(19) United States
(12) Patent Application Publication
(10) Pub. No.: US 2020/0342722 A1
(43) Pub. Date: Oct. 29, 2020

(54) Straightforward Cash Dispenser

(71) Applicant: Top Vending Machine Electronics Co., Ltd., Taoyuan City (TW)

(72) Inventor: Yuan-Fong Chang, Taoyuan City (TW)

(21) Appl. No.: 16/391,453

(22) Filed: Apr. 23, 2019

(51) Int. Cl. G07F 19/00; G07G 1/00; G07G 1/01; G07G 1/10; G07G 1/12

(52) U.S. Cl. CPC G07F 19/203; G07G 1/0027; G07G 1/12; G07G 1/10; G07G 1/01

(57) ABSTRACT

A straightforward cash dispenser includes a body unit having a body and a cash box mounted on top of the body. The body includes a front side having an exit slot. A bill conveying device is mounted in the body. A bill counting device is mounted inside the body and adjacent to an inner side of the body. The bill counting device is configured to convey a bill inside the body into the bill conveying device in a widthwise direction of the bill and in a lateral direction of the body. The bill conveying device is configured to output the bill via the exit slot in a lengthwise direction of the bill.

### BACKGROUND OF THE INVENTION

The present invention relates to a straightforward cash dispenser and, more particularly, to a cash dispenser including a bill counting device and a bill conveying device, with the bill counting device and the bill conveying device conveying bills in different directions, such that the bills can exit via an exit slot in a lengthwise direction of the bills.

Cash dispensers are generally used in automated teller machines, bill counting machines, etc. Currently available cash dispensers use a mechanism that outputs bills via an exit slot in a widthwise direction of the bills. As a result, a larger portion of the panel of an automated teller machine or a bill counting machine is occupied.

If the bill output direction is changed, the bill will move in a longer travel during a bill counting operation, which not only increases the user's waiting time but increases the risk of a bill getting stuck. Thus, a need exists for a novel cash dispenser that can output the bill via an exit slot in the lengthwise direction of the bill without increasing the travel of the bill in the cash dispenser.

### BRIEF SUMMARY OF THE INVENTION

The primary objective of the present invention is to provide a cash dispenser using a bill counting device to convey a single bill in a cash box in the widthwise direction of the bill to a bill conveying device. Then, the bill conveying device outputs a stack of bills to the exit slot in the lengthwise direction of the bills. Thus, the widths of the front side and the exit slot of the cash dispenser can be reduced, such that the cash dispenser can be more easily installed in an automated teller machine, a bill counting machine, etc. As a result, the space can be utilized more efficiently without increasing the risk of a bill getting stuck and the waiting time.

To achieve the above objective, the present invention provides a straightforward cash dispenser including a body unit having a body and a cash box mounted on top of the body. The body includes a front side having an exit slot. A bill conveying device is mounted in the body. A bill counting device is mounted inside the body and adjacent to an inner side of the body. The bill counting device is configured to convey a bill inside the body into the bill conveying device in a widthwise direction of the bill and in a lateral direction of the body. The bill conveying device is configured to output the bill via the exit slot in a lengthwise direction of the bill.

In an example, the body includes a bill detector configured to detect bills in the cash box.

In an example, the bill conveying device includes a bottom board, a pressing board, and a bill conveying wheel unit. The bottom board is fixed in the body and includes a surface having a first hollow portion. An end of the bottom board is aligned with the exit slot of the body. The pressing board is mounted above the bottom board and is connected to the body via a linking rod. The pressing board includes a surface having a second hollow portion. The bill conveying wheel unit includes a first bill conveying wheel, a second bill conveying wheel, and a bill conveying driver configured to drive the first bill conveying wheel and the second bill conveying wheel. The first bill conveying wheel and the second bill conveying wheel are exposed via the first hollow portion and the second hollow portion, respectively. The bill conveyed by the bill counting device is positioned between the bottom board and the pressing board by the pressing board. The bill conveying wheel unit is configured to output the bill via the exit slot.

In an example, the bill conveying device includes a bill returning wheel unit at another end of the bottom board opposite to the exit slot. The bill returning wheel unit is connected to the bill conveying wheel unit via a transmission belt. The body includes a bill recovery box mounted below the bottom board and the bill returning wheel unit.

In an example, the second bill conveying wheel of the bill conveying wheel unit is made of an elastic material, and the second bill conveying wheel includes an outer side having a chambered face.

In an example, the bill counting device includes a transmission unit and a pressing and holding wheel unit. The transmission unit includes a transmission shaft, a transmission wheel mounted on the transmission shaft, and a transmission driver configured to rotate the transmission shaft. The transmission shaft is rotatably mounted to a side of the body. The pressing and holding unit includes a connecting rod fixed to the body, an adjusting seat, and a pressing and holding wheel connected to the adjusting seat. The adjusting seat is mounted on the connecting rod and is configured to be adjusted to a desired position and is then fixed to the connecting rod by at least one fastener, thereby positioning the pressing and holding wheel above the transmission wheel. The bill moved out of the cash box is conveyed to the bill conveying device through the pressing and holding wheel and the transmission wheel.

In an example, the pressing and holding unit of the bill counting device further includes a shaft, a single direction bearing mounted on the shaft, and a rotational and positioning device connected to the shaft. The shaft is rotatably mounted to the adjusting seat. The pressing and holding wheel is mounted on the shaft. The rotational and positioning device includes a base, a fixing rod, and an adjusting plate. The base is fixed to the body and is located adjacent to a side of the connecting rod. An adjusting screw is mounted on the base. A push nut is mounted on the base and is threadedly coupled with the adjusting screw. The fixing rod is fixed to the body. An elastic element is disposed between the fixing rod and the connecting rod. The adjusting plate is fixed to the connecting rod. A side of the adjusting plate extends to a side of the push nut.

In an example, the adjusting seat of the bill counting device includes a fulcrum and two adjusting holes spaced from each other. Two fasteners respectively extend through the two adjusting holes and are fixed to the connecting rod.

In an example, the transmission shaft of the transmission unit is connected to a transmission gear. The transmission unit further includes a bill feeding conveying unit having an axle. A bill feeding member is disposed on the axle. A driven gear is mounted on a side of the axle and meshes with the transmission gear.

The present invention will become clearer in light of the following detailed description of illustrative embodiments of this invention described in connection with the drawings.

### DESCRIPTION OF THE DRAWINGS

FIG. 1 is a perspective view of a straightforward cash dispenser of an embodiment according to the present invention.

FIG. 2 is a partial, perspective view of the straightforward cash dispenser of FIG. 1.

FIG. 3 is another partial, perspective view of the straightforward cash dispenser of FIG. 1.

FIG. 4 is a partial, perspective view of a bill counting device of the straightforward cash dispenser of FIG. 1.

FIG. 5 is a perspective view of a bill conveying device of the straightforward cash dispenser of FIG. 1.

FIG. 6 is a partial, cross-sectioned view of the bill counting device of the straightforward cash dispenser of FIG. 1.

FIG. 7 is a diagrammatic view illustrating the bill conveying device ready to convey a stack of bills.

FIG. 7A is a diagrammatic view illustrating a second bill conveying wheel pressing against the stack of bills.

FIG. 7B is a diagrammatic view illustrating the second bill conveying wheel pushing the stack of bills.

FIG. 8 is a diagrammatic view illustrating a bill returning operation by the bill conveying device.

FIG. 9 is a perspective view of a pressing and holding unit of the straightforward cash dispenser of FIG. 1.

FIG. 10 is an exploded, perspective view of a portion of the pressing and holding unit.

FIG. 11 is a side view of the pressing and holding unit.

### DETAILED DESCRIPTION OF THE INVENTION

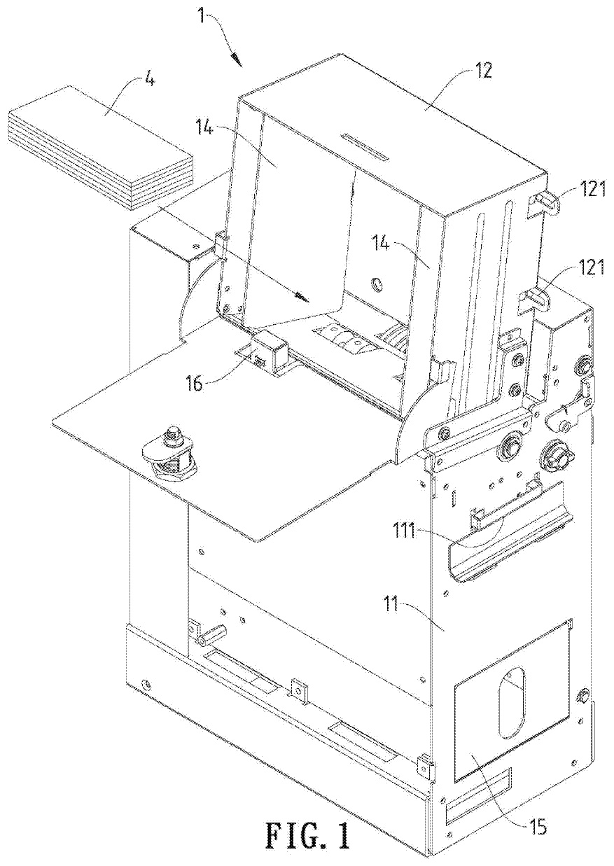

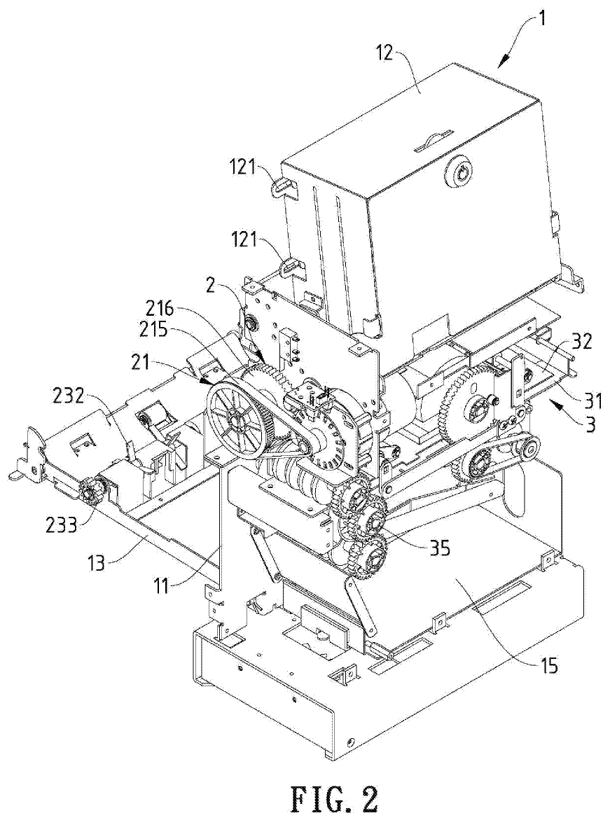

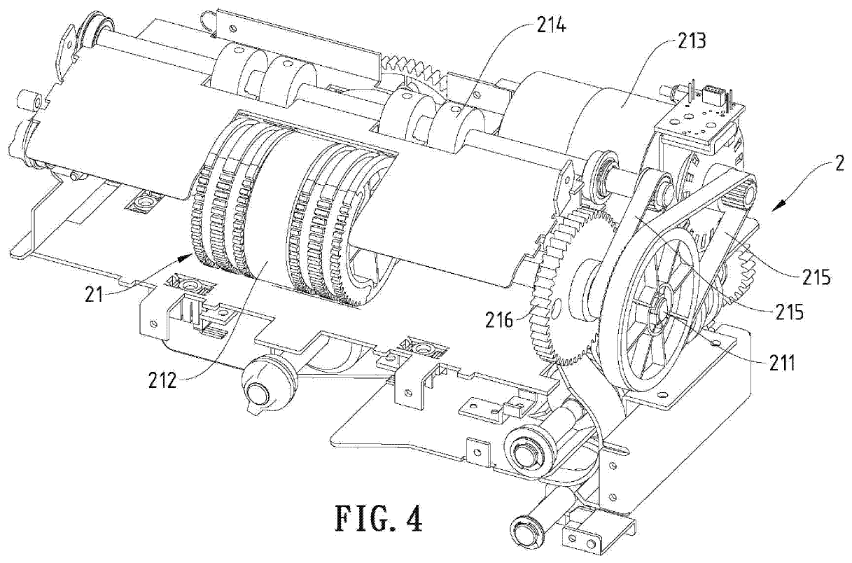

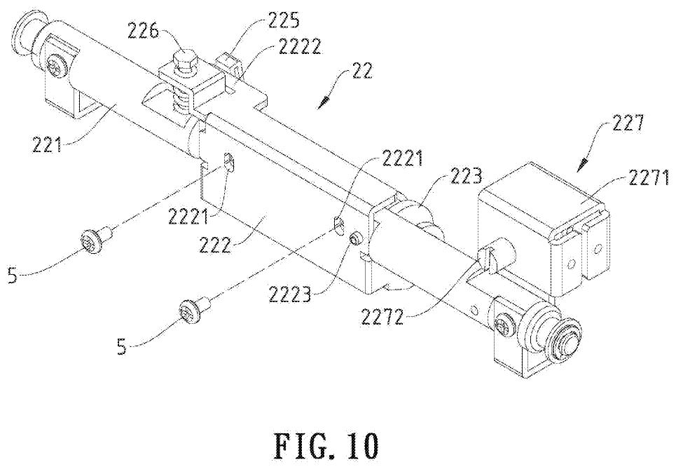

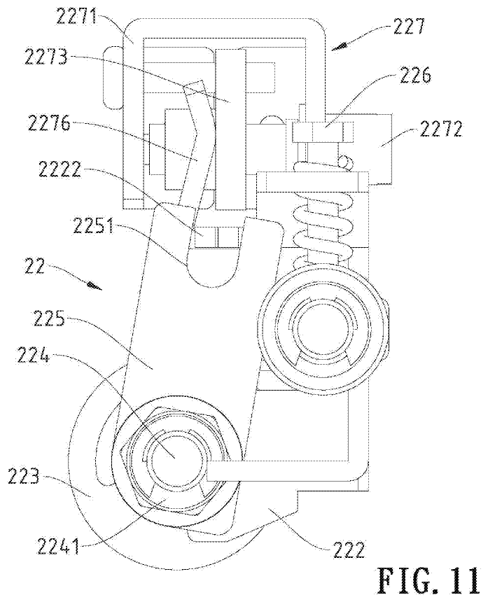

With reference to FIGS. 1-11, a straightforward cash dispenser of an embodiment according to the present invention includes a body unit 1, a bill counting device 2, and a bill conveying device 3. The bill conveying device 3 is mounted in a body 11 of the body unit 1. The bill counting device 2 is mounted at an inner side of the body 11.

The body unit 1 includes the body 11, a cash box 12, and a side cover 13 (FIGS. 1-3). The cash box 12 is mounted on top of the body 11. The side cover 13 is pivotably mounted to a side of the body 11. A bill recovery box 15 is mounted to a lower portion of the body 11 and can be removed out of the body 11. A bill detector 16 is mounted to the body 11 and is configured to detect bills 4 in the cash box 12. Two side boards 14 are mounted to the body 11 and can be moved to position the bills 4. Elongated adjusting hole 121 are provided at a side of the cash box 12. The side boards 14 are fixed by extending fasteners 17 through the elongated adjusting holes 121. The body 11 further includes a front side having an exit slot 111. A bill counter 18 is mounted on the side cover 13.

The bill counting device 2 includes a transmission unit 21, a pressing and holding wheel unit 22, and a bill feeding unit 23. The transmission unit 21 includes a transmission shaft 211, a transmission wheel 212, a transmission driver 213, and at least one bill pushing wheel 214 (FIGS. 1-6). The transmission wheel 212 is mounted on the transmission shaft 211 rotatably mounted to a side of the body 11. A transmission gear 216 is mounted on an end of the transmission shaft 211. The at least one bill pushing wheel 214 is rotatably mounted to an upper side of the body 11 and partially extends into the cash box 12. The least one bill pushing wheel 214 is connected to the transmission shaft 211 via a transmission belt 215. The transmission shaft 211 is connected to the transmission driver 213 via another transmission belt 215.

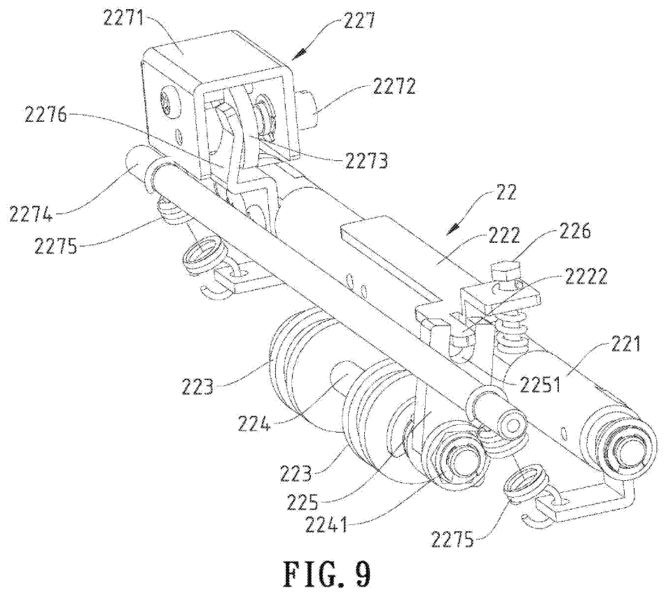

The pressing and holding unit 22 is disposed above the transmission wheel 212 and includes a connecting rod 221, an adjusting seat 222, a pressing and holding wheel 223, a shaft 224, a bracket 225, and a rotational and positioning device 227 (FIGS. 9-11). The connecting rod 221 is fixed to the body 11. A single direction bearing 2241 is mounted on the shaft 224. The pressing and holding wheel 223 is mounted on the transmission shaft 224 rotatably mounted to the adjusting seat 222. The adjusting seat 222 includes at least two adjusting holes 2221 spaced from each other and a fulcrum 2223 positioned on the connecting rod 221. Fasteners 5 respectively extend through the at least two adjusting holes 2221 and are fixed to the connecting rod 221.

The bracket 225 is mounted to a side of the shaft 224 and includes a bracket hole 2251 in a distal end thereof. A supporting portion 2222 extends from a side of the bracket 222 and has a distal end located in the bracket hole 2251. An adjusting member 226 is disposed on the adjusting seat 222. The rotational and positioning device 227 includes a base 2271, a fixing rod 2274, and an adjusting plate 2276. The base 2271 is fixed to the body 11 and is located adjacent to a side of the connecting rod 221. An adjusting screw 2272 is mounted on the base 2271. A push nut 2273 is mounted on the base 2271 and is threadedly coupled with the adjusting screw 2272. The fixing rod 2274 is fixed to the body 11 and is located on a side of the connecting rod 221.

An elastic element 2275 is disposed between the fixing rod 2274 and the connecting rod 221, biasing the connecting rod 221 to rotate towards the fixing rod 2274. The adjusting plate 2276 is fixed to the connecting rod 221. A side of the adjusting plate 2276 extends to a side of the push nut 2273. The adjusting screw 2272 can be rotated to actuate the push nut 2273 to push the adjusting plate 2276, rotating the connecting rod 221. The bill feeding unit 23 includes an axle 231 rotatably mounted to the side cover 13 of the body unit 1. A bill feeding member 232 is mounted on the axle 231. A driven gear 233 is mounted on an end of the axle 231. The driven gear 233 meshes with the transmission gear 216 when the side cover 13 is in a closed position relative to the body 11.

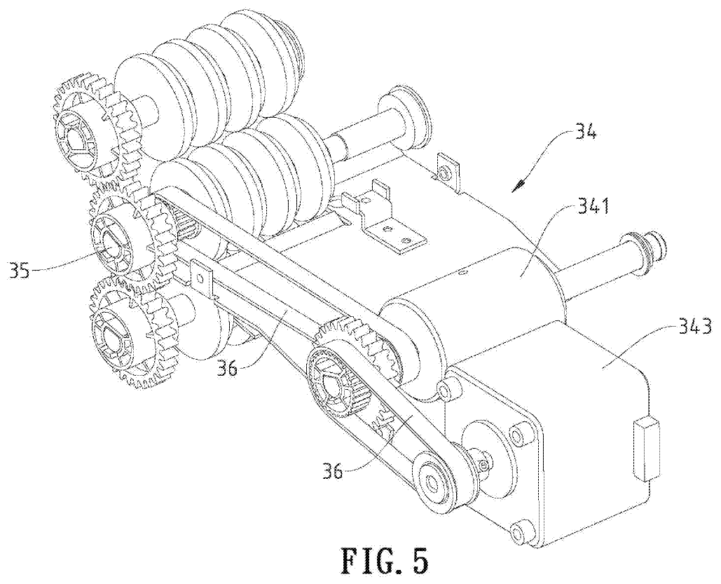

The bill conveying device 3 includes a bottom board 31, a pressing board 32, a bill conveying wheel unit 34, and a bill returning wheel unit 35 (FIGS. 5-7). The bottom board 31 is fixed in the body 11 and includes a surface having a first hollow portion 311. An end of the bottom board 31 is aligned with the exit slot 111 of the body 11. The pressing board 32 is mounted above the bottom board 31 and is connected to the body 11 via a linking rod 33. The pressing board 32 includes a surface having a second hollow portion 321. The bill conveying wheel unit 34 includes a first bill conveying wheel 341, a second bill conveying wheel 342, and a bill conveying driver 343 configured to drive the first bill conveying wheel 341 and the second bill conveying wheel 342. The first bill conveying wheel 341 and the second bill conveying wheel 342 are exposed via the first hollow portion 311 and the second hollow portion 321, respectively. The second bill conveying wheel 342 is made of an elastic material. The second bill conveying wheel 342 includes an outer side having a chambered face 3421. The bill returning wheel unit 35 is disposed at another end of the bottom board 31 opposite to the exit slot 111. The bill conveying driver 343, the first bill conveying wheel 341, the second bill conveying wheel 342, and the bill returning wheel unit 35 are connected via transmission belts 36.

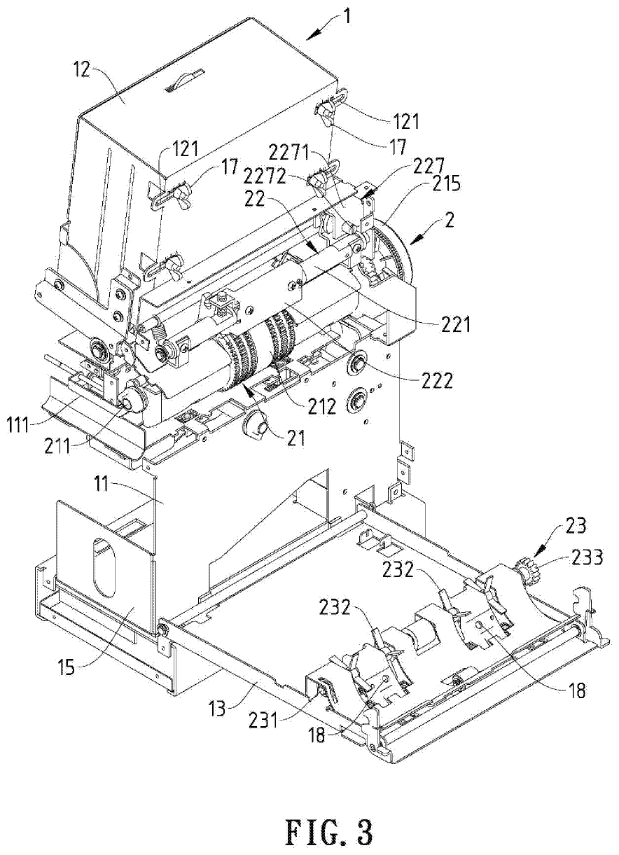

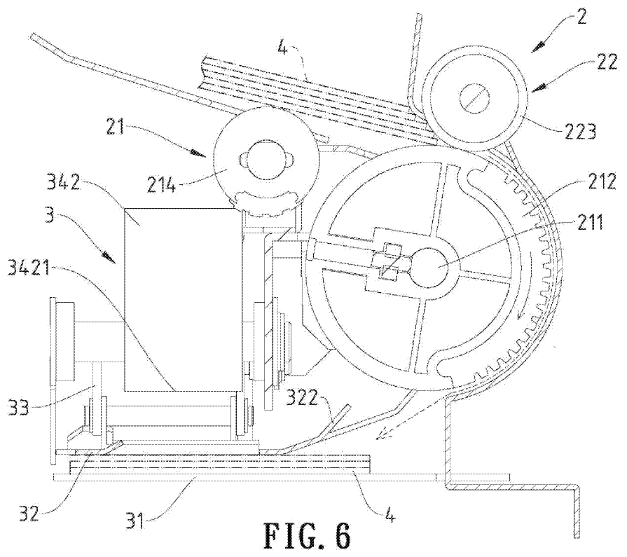

With reference to FIGS. 1-8, in use, bills 4 are placed into the cash box 12 (see FIG. 1), the elongated adjusting slots 121 of the cash box 12 are used to adjust the position of the side boards 14, and the fasteners 17 are used to position the side boards 14. With reference to FIG. 6, when a bill 4 is moved out of the cash box 12, the transmission driver 213 of the bill counting device 2 drives the bill pushing wheel 214 and the transmission wheel 212 to rotate, such that the bill 4 is pushed by the bill pushing wheel 214 and the bill feeding member 232 (FIG. 3) and then moves to a position between the transmission wheel 212 and the pressing and holding wheel 223. Then, the bill 4 is moved by the transmission wheel 212 into a position between the bottom board 31 and the pressing board 32. Since the pressing board 32 has a guiding portion 322 at a side thereof, the bill 4 enters smoothly.

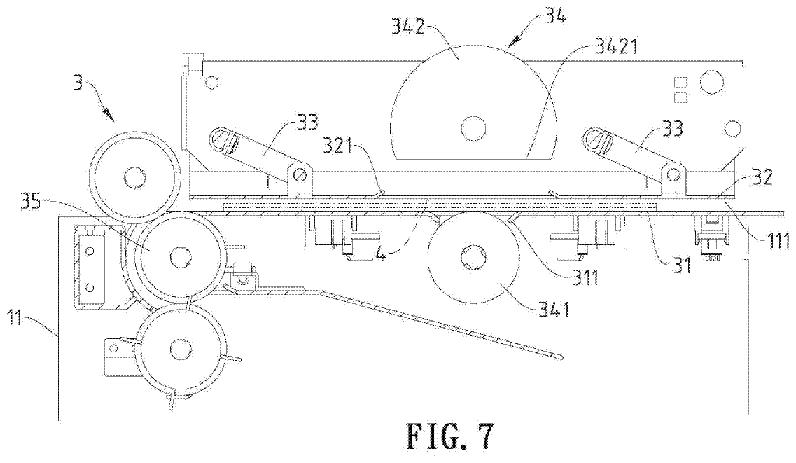

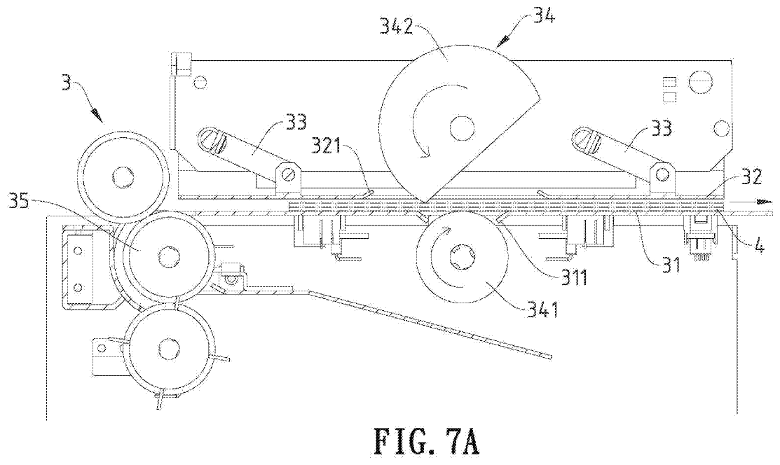

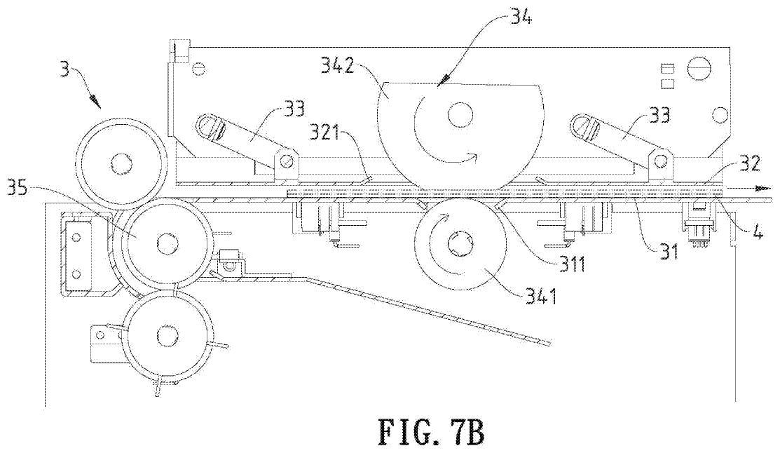

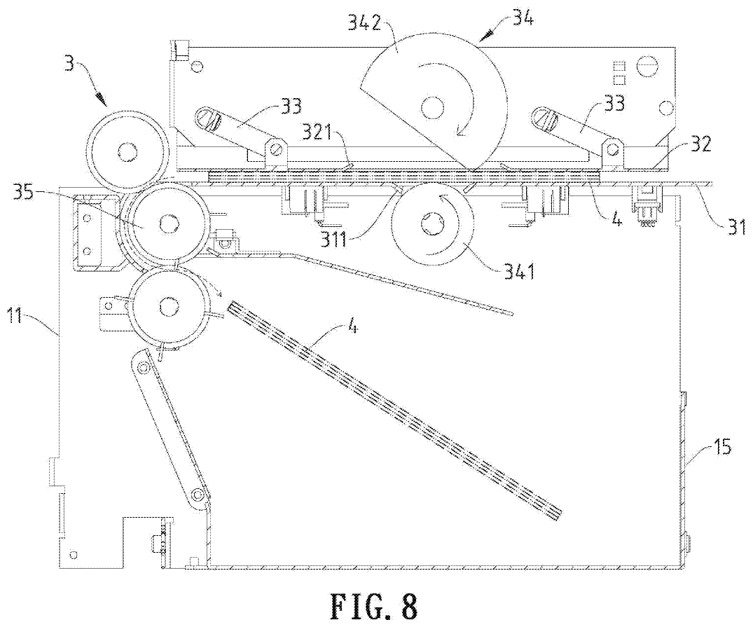

With reference to FIGS. 5, 7, 7A, and 7B, when a desired number of bills 4 has entered the bill conveying device 3, the first bill conveying wheel 341 and the second bill conveying wheel 342 output the stack of bills 4 via the exit slot 111. Accordingly, the bill counting device 2 conveys a single bill 4 in the cash box 12 to the bill conveying device 3 in the widthwise direction of the bill 4. Then, the bill conveying device 3 outputs the stack of bills 4 to the exit slot 111 in the lengthwise direction of the stack of bills 4. Furthermore, since the second bill conveying wheel 342 is made of an elastic element, when the second bill conveying wheel 342 rotates, the outer edge of the second bill conveying wheel 342 presses against the stack of bills 4 and deforms, assuring the stack of bills 4 to be smoothly outputted via the exit slot 111. With reference to FIG. 8, when the number of the stack of bills 4 entering the bill conveying device 3 is more than or less than the desired number, the bill conveying driver 343 actuates the first bill conveying wheel 341 and the second bill conveying wheel 342, and the stack of bills 4 is moved towards the bill returning wheel 35 and then moved into the recovery box 15 at the lower portion of the body 11.

With reference to FIGS. 6 and 9-11, to assure the bill 4 is conveyed smoothly through the bill counting device 2 to the position between the bottom board 31 and the pressing board 32, the matching between the transmission wheel 212 and the pressing and holding wheel 223 is critical. The adjusting member 226 can be rotated to adjust its position relative to the adjusting holes 2221, such that the adjusting seat 222 is adjusted to a proper position through the fulcrum 2223, thereby retaining a parallel relationship between the pressing wheel 212 and the pressing and holding wheel 223. Then, fasteners 5 are used for fixing purposes. The holding force between the pressing wheel 212 and the pressing and holding wheel 223 can be obtained by rotating the adjusting screw 2272, actuating the push nut 2273 to push the adjusting plate 2276. The connecting rod 221 rotates to move the pressing and holding wheel 223 towards or away from the transmission wheel 212.

Although specific embodiments have been illustrated and described, numerous modifications and variations are still possible without departing from the scope of the invention. The scope of the invention is limited by the accompanying claims.

1. A straightforward cash dispenser comprising:
a body unit including a body and a cash box mounted on top of the body, wherein the body includes a front side having an exit slot;
a bill conveying device mounted in the body; and
a bill counting device mounted inside the body and adjacent to an inner side of the body, wherein the bill counting device is configured to convey a bill inside the body into the bill conveying device in a widthwise direction of the bill and in a lateral direction of the body, and wherein the bill conveying device is configured to output the bill via the exit slot in a lengthwise direction of the bill.

2. The straightforward cash dispenser as claimed in claim 1, wherein the body includes a bill detector configured to detect bills in the cash box.

3. The straightforward cash dispenser as claimed in claim 1, wherein the bill conveying device includes a bottom board, a pressing board, and a bill conveying wheel unit, wherein the bottom board is fixed in the body and includes a surface having a first hollow portion, wherein an end of the bottom board is aligned with the exit slot of the body, wherein the pressing board is mounted above the bottom board and is connected to the body via a linking rod, wherein the pressing board includes a surface having a second hollow portion, wherein the bill conveying wheel unit includes a first bill conveying wheel, a second bill conveying wheel, and a bill conveying driver configured to drive the first bill conveying wheel and the second bill conveying wheel, wherein the first bill conveying wheel and the second bill conveying wheel are exposed via the first hollow portion and the second hollow portion, respectively, wherein the bill conveyed by the bill counting device is positioned between the bottom board and the pressing board by the pressing board, and wherein the bill conveying wheel unit is configured to output the bill via the exit slot.

4. The straightforward cash dispenser as claimed in claim 3, wherein the bill conveying device includes a bill returning wheel unit at another end of the bottom board opposite to the exit slot, wherein the bill returning wheel unit is connected to the bill conveying wheel unit via a transmission belt, and wherein the body includes a bill recovery box mounted below the bottom board and the bill returning wheel unit.

5. The straightforward cash dispenser as claimed in claim 3, wherein the second bill conveying wheel of the bill conveying wheel unit is made of an elastic material, and wherein the second bill conveying wheel includes an outer side having a chambered face.

6. The straightforward cash dispenser as claimed in claim 1, wherein the bill counting device includes a transmission unit and a pressing and holding wheel unit, wherein the transmission unit includes a transmission shaft, a transmission wheel mounted on the transmission shaft, and a transmission driver configured to rotate the transmission shaft, wherein the transmission shaft is rotatably mounted to a side of the body, wherein the pressing and holding unit includes a connecting rod fixed to the body, an adjusting seat, and a pressing and holding wheel connected to the adjusting seat, wherein the adjusting seat is mounted on the connecting rod and is configured to be adjusted to a desired position and is then fixed to the connecting rod by at least one fastener, thereby positioning the pressing and holding wheel above the transmission wheel, wherein the bill moved out of the cash box is conveyed to the bill conveying device through the pressing and holding wheel and the transmission wheel.

7. The straightforward cash dispenser as claimed in claim 6, wherein the pressing and holding unit of the bill counting device further includes a shaft, a single direction bearing mounted on the shaft, and a rotational and positioning device connected to the shaft, wherein the shaft is rotatably mounted to the adjusting seat, wherein the pressing and holding wheel is mounted on the shaft, wherein the rotational and positioning device includes a base, a fixing rod, and an adjusting plate, wherein the base is fixed to the body and is located adjacent to a side of the connecting rod, wherein an adjusting screw is mounted on the base, wherein a push nut is mounted on the base and is threadedly coupled with the adjusting screw, wherein the fixing rod is fixed to the body, wherein an elastic element is disposed between the fixing rod and the connecting rod, wherein the adjusting plate is fixed to the connecting rod, and wherein a side of the adjusting plate extends to a side of the push nut.

8. The straightforward cash dispenser as claimed in claim 6, wherein the adjusting seat of the bill counting device includes a fulcrum and two adjusting holes spaced from each other, and wherein two fasteners respectively extend through the two adjusting holes and are fixed to the connecting rod.

9. The straightforward cash dispenser as claimed in claim 6, wherein the transmission shaft of the transmission unit is connected to a transmission gear, wherein the transmission unit further includes a bill feeding conveying unit having an axle, wherein a bill feeding member is disposed on the axle, wherein a driven gear is mounted on a side of the axle and meshes with the transmission gear.
